(19) United States
(12) Patent Application Publication
(10) Pub. No.: US 2024/0410830 A1
(43) Pub. Date: Dec. 12, 2024

(54) APPARATUS AND METHODS FOR DETECTION OF CHEMICALS USING OPTICAL SENSORS

(71) Applicant: UNIVERSITY COURT OF THE UNIVERSITY OF ST ANDREWS, Fife (GB)

(72) Inventors: Ross N GILLANDERS, Fife (GB); James ME GLACKIN, Fife (GB); Graham TURNBULL, Fife (GB); Ifor David William SAMUEL, Fife (GB)

(21) Appl. No.: 18/700,393

(22) PCT Filed: Oct. 11, 2022
(86) PCT No.: PCT/GB2022/052575

§ 371 Date: Apr. 11, 2024

(30) Foreign Application Priority Data
Oct. 12, 2021 (GB) 2114557.8

(51) Int. Cl. G01N 21/64

(52) U.S. Cl. CPC G01N 21/6428; G01N 21/6489; G01N 2021/6432

(57) ABSTRACT

An apparatus (50) for detecting a first analyte (42) comprises a first layer (51) comprising a photoluminescent material; and a second layer (52) provided on the first layer (51), wherein the second layer (52) comprises a polymeric material configured to allow the first analyte (42) to permeate through the second layer (52).

### FIELD OF THE INVENTION

The present invention relates to an apparatus and method for detecting an analyte. In particular, but not exclusively, the invention relates to an apparatus and method for detecting an analyte using a photoluminescent sensor material.

### BACKGROUND

Pesticide contamination is a global phenomenon, and current methods of water contamination detection are often bulky, costly and slow-detection events can be up to 6 months. For example, conventional technologies such as HPLC and GC-MS for allow detection of specific chemicals such as pesticides. However, the associated equipment is expensive, bulky, and not portable.

Optical sensing is a well-known detection method for many classes of chemicals. However, where these sensors are applied to water analysis, they tend to be used for measuring of standard water quality parameters like turbidity, DO, CO₂, PH, or chlorine content.

Thin film optical sensors are highly sensitive methods for the detection of a wide variety of analytes and parameters, and have the advantage of being easily integrated with portable, inexpensive instrumentation.

Such films typically use organic semiconductors, which may be based for example on conducting conjugated polymers. The conjugated nature of such polymers makes them particularly suitable for absorption and florescence applications. Other types of organic semiconductor molecules also exist. When excited by photons of certain wavelengths, the organic semiconductor absorbs energy, which is then released in the form of fluorescence, and which can be measured. A useful metric to quantify the performance of a light emitting material is the photoluminescence quantum yield (PLQY). The PLQY is defined as the ratio of emitted photons to absorbed photons.

Examples of such polymers are shown in Table 1.

TABLE 1

| | Manu- | | |
|---|---|---|---|
| Polymer | facturer | Structure | Alternative names |
| Super Yellow | Merck | 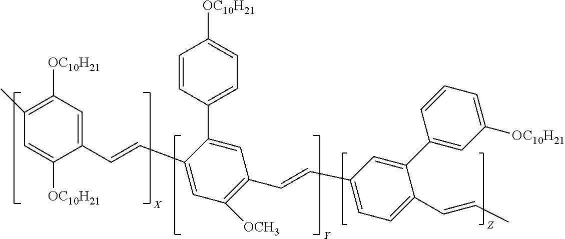 | PDY-132, Poly[2,5-di(3,7- decyloxy)-1,4- phenylenevinylene- co-3-(4′-(3′,7″- decyloxy)phenyl)- 1,4- phenylenevinylene- coan-3-(3′-(3′,7- decyloxy)phenyl)- 1,4- phenylenevinylene] |
| PFO | American Dye Source | 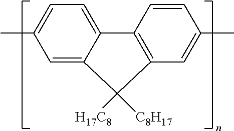 | Polyfluorene, ADS129BE, PF8, Poly[9,9- dioctylfluorenyl-2,7- diyl] |
| F8_{0.9}BT_{0.1} | American Dye Source | 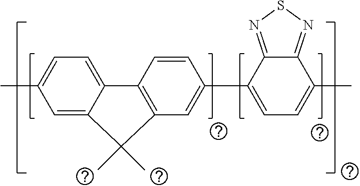 | ADS233YE, Poly[(9,9- dioctylfluorenyl-2,7- diyl)-co-(1,4-benzo- 2,1′,3-thiadiazole)] 10% benzothiadiazole |
| ADS125GE | American Dye Source | 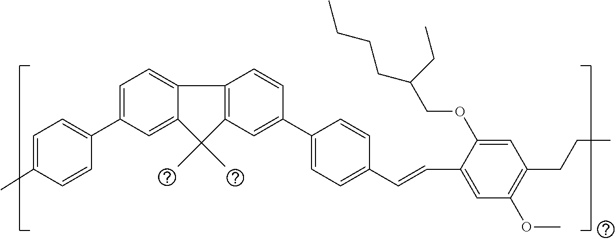 | Poly[(9,9- dioctylfluorenyl-2,7- diyl)-co-(1,4- diphenylene- vinylene-2- methoxy-5-2- ethylhexyloxy- benzene)] |

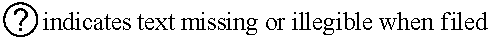

A process known as fluorescence quenching can occur when certain chemical compounds come into contact with a conjugated polymer used to measure photoluminescence. This is the case when such compounds contain chemical groups that can lead to an electron transfer or exciton transfer from the photo-excited polymer. Such compounds may include, for example nitro functional groups (—NO₂). Therefore, fluorescence quenching may be observed in the presence of nitroaromatic compounds, which include explosive molecules such as 2,4,6-trinitrotoluene (TNT), 2,4-dinitrotoluene (DNT) or 1,3-dinitrobenzene (DNB), or distractant (e.g. pesticides, herbicides, insecticides) such as Dinoseb (2-(sec-butyl)-4,6-dinitrophenol).

Examples of such compounds are shown in Table 2.

TABLE 2

| | | HOMO | LUMO | Vapour |
|---|---|---|---|---|
| Analyte | Structure | (eV) | (eV) | Pressure (ppb) |
| 2,4-DNT | 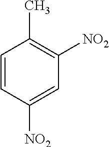 | −7.76 | −3.22 | 180 |
| 2,4,6-TNT | 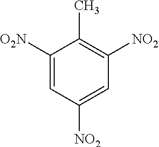 [SMILES: Cc1c([N+](=O)[O-])cc([N+](=O)[O-])cc1[N+](=O)[O-]] | −8.46 | −3.49 | 11 |
| 1,3-DNB | 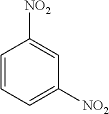 [SMILES: O=[N+]([O-])c1cccc([N+](=O)[O-])c1] | −7.99 | −3.43 | 30 |
| DMDNB | 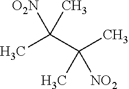 | −8.23 | −2.39 | 2700 |
| Dinoseb | 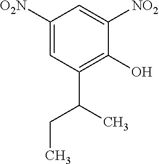 [SMILES: CCC(C)c1cc([N+](=O)[O-])cc([N+](=O)[O-])c1O] | −8.23 | −2.39 | 0.06 |

Other examples are also shown in FIG. 1.

R. N Gillanders, I. D. W. Samuel, G. A Turnbull, “A low-cost, portable optical explosive-vapour sensor”, Sensors and Actuators, B: Chemical 245 (2017) 334-340, discloses a portable photoluminescence-based sensor for nitroaromatic vapours (and in particular, landmine explosive vapours) based on the conjugated polymer Super Yellow integrated into an instrument comprising an excitation LED, photodiode, Arduino microprocessor and pumping mechanics for vapour delivery.

A problem with existing photoluminescent sensors is their lack of specificity. As explained above, quenching of the photoluminescent material will normally occur in the presence of any compound having a chemical group capable of accepting an electron or exciton from the photo-excited sensor material. Therefore, if detection of low levels of a nitro-containing explosive compound is desired, the presence in the environment of nitro-containing distractants will interfere with and affect the analysis, and vice versa. This may result in the occurrence of “false positive” results during detection of a target analyte.

It is an object of the invention to address and/or mitigate one or more problems associated with the prior art.

### SUMMARY

The present invention is based upon the finding that it is possible to provide a highly sensitive measuring apparatus that uses the high sensitivity of a photoluminescent layer, combined with the selective detection of a target analyte, by providing the sensing layer with a selective filter layer made of a Molecularly Imprinted Sol-Gel polymer.

According to a first aspect, there is provided an apparatus for detecting a first analyte, the apparatus comprising:
a first layer comprising a photoluminescent material; and
a second layer provided on the first layer, wherein the second layer comprises a polymeric material configured to allow the first analyte to permeate through the second layer.

Typically, the first layer may comprise a polymeric layer. The first layer may comprise a photoluminescent organic material, e.g. a photoluminescent organic semiconductor material, for example a photoluminescent polymer material, typically a polyunsaturated polymer material. The photoluminescent material may comprise a polyaromatic polymer, for example a homo- or co-polymer of poly(1,4-phenylenevinylene), or a polyfluorene homo- or co-polymer, or optionally substituted derivatives thereof.

Advantageously, the photoluminescent material may be capable of being quenched by the first analyte. By such provision, the presence of the first analyte may be detected using a photoluminescence measuring device. A person of ordinary skill in the art would understand the possible mechanisms that are involved in luminescence quenching. Possible mechanisms may involve, for example, photo-excited electron transfer or resonant exciton transfer.

The first layer, e.g. photoluminescent material, may typically be provided as a film. The film may have a thickness of about 5-500 nm, e.g. 10-100 nm, e.g. about 50 nm.

The second layer may comprise a sol-gel material, e.g. a sol-gel polymeric material. The second layer may comprise a sol-gel inorganic polymer, e.g. a siloxane derivative. The second layer may comprise a polysiloxane sol-gel.

The second layer may typically formed by polymerisation, e.g. condensation, of a composition comprising a silicon alkoxide precursor. The silicon alkoxide precursor may be a compound represented by Formula (I):

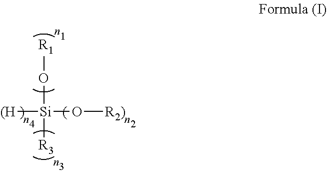

wherein R₁, R₂, R₃, are each independently an optionally substituted alkyl group, and
n₁, n₂, n₃, n₄ are each 0, 1, 2, 3 or 4, wherein n₁+n₂+n₃+n₄ equals 4.

Typically, n₄=0.

Typically, R₁, R₂ may each be independently an optionally substituted C1-C5 alkyl group, e.g. an optionally substituted C1-C3 alkyl group. R₁, R₂ may each be a C1-C5 alkyl group, e.g. a C1-C3 alkyl group.

R₃ may each be independently an optionally substituted C1-C5 alkyl group, e.g. an optionally substituted C1-C3 alkyl group. R₃ may be an alkyl group substituted by one or more halogen group, amino group, hydroxyl group, or the like.

R₃ may be a halogenated C1-C5 alkyl group.

R₃ may be an amino-containing C1-C5 alkyl group.

The silicon alkoxide precursor may be a compound represented by Formula (I)a:

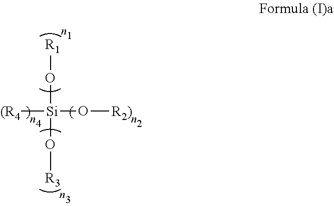

wherein R₁, R₂, R₃, are each independently an alkyl group,
R₄ is independently an optionally halogenated or aminated C1-C5 alkyl group, and
n₁, n₂, n₃, n₄ are each 0, 1, 2, 3 or 4, wherein n₁+n₂+n₃+n₄ equals 4.

Typically, n₄=1.

The silicon alkoxide precursor may comprise one or more selected from the list consisting of n-propyltriethoxysilane (PTEOS), trimethoxy(3,3,3-trifluoropropyl)silane (TFP-TMOS), (3-aminopropyl)triethoxysilane (APTES), and tetramethyl orthosilicate (TMOS).

The silicon alkoxide precursor may comprise n-propyltriethoxysilane (PTEOS) and trimethoxy(3,3,3-trifluoropropyl)silane (TFP-TMOS).

The silicon alkoxide precursor may comprise (3-aminopropyl)triethoxysilane (APTES) and tetramethyl orthosilicate (TMOS).

The second layer may be provided as a coating on the first layer.

The second layer may have a thickness of about 5-500 nm, e.g. 200-300 nm, e.g. about 250 nm.

Advantageously, the material of the second layer may be configured, e.g. imprinted, so as to allow the first analyte to pass through the second layer. Typically, the second layer may be imprinted with a first template selected to allow the first analyte to pass through the second layer. The first template may be substantially identical to or may be similar to the first analyte.

The second layer may be prepared by polymerising a precursor of the sol-gel material. Typically, the first template may be provided within the sol-gel precursor, e.g., before polymerisation of the sol-gel polymer. By such provision, during polymerisation, the first template may create openings or channels within the second layer which have dimensions, e.g. having shape and/or size, substantially identical to or similar to the first analyte. Thus, after the first template has been removed, the second layer may permit the first analyte to pass through the openings or channels created by the first template.

Thus, the second layer may comprise or may be defined as a Molecularly Imprinted Sol-Gel (‘MISG’) material.

Advantageously, the second layer may act as a selective molecular filter for the first analyte, allowing passage of the first analyte through the second layer, but preventing or limiting passage of other substances.

It will be understood that the second layer may not necessarily prevent passage of all other substances, as there may be certain compounds, for example smaller compounds, that may be able to pass through the second layer, e.g. channels thereof. However, advantageously, the provision of a Molecularly Imprinted Sol-Gel second layer may prevent or may limit passage of substances, e.g. of a second analyte, being either larger or having a comparable size, and/or having similar chemical groups or structures and which would be able to quench the photoluminescent material of the first layer.

The first analyte may comprise or may be a nitro-containing compound, typically a nitroaromatic compound.

The first analyte may be an explosive molecules such as 2,4,6-trinitrotoluene (TNT), 2,4-dinitrotoluene (DNT) or 1,3-dinitrobenzene (DNB).

The first analyte may be a distractant (e.g. a pesticide, a herbicide, an insecticide or the like) such as Dinoseb (2-(sec-butyl)-4,6-dinitrophenol), 3-5-dinitro-2-hydroxytoluene, or binapacryl (2-(butan-2-yl)-4,6-dinitrophenyl 3-methylbut-2-enoate).

The first analyte may comprise a pharmaceutical compound. It will be understood that the present apparatus, e.g. second layer, may be tailored such that the second layer acts as a selective molecular filter for a desired first analyte of interest. Thus, the present invention should not be understood as being limited to a specific type of first analyte.

When the first analyte is a nitro-containing compound, the second layer is configured to allow passage of the first analyte through the second layer, but to prevent or limit passage of other nitro-containing compounds. The first analyte may be provided in a gaseous carrier, e.g. in a vapour carrier.

The first analyte may be provided in a liquid carrier, e.g. in an aqueous carrier.

Typically, the apparatus may comprise a substrate layer. The first layer may be provided on the substrate layer. The substrate layer may typically be made of glass, fused silica, silicon, or polymeric materials such as PET another polymer.

The second layer may be provided on a surface of the first layer opposite the substrate layer.

According to a second aspect of the present invention there is provided a method of preparing an apparatus for detecting a first analyte, the method comprising:
providing a first layer comprising a photoluminescent material; and
providing a second layer on the first layer, wherein the second layer comprises a polymeric material configured to allow the first analyte to permeate through the second layer.

The method may comprise providing the first layer on a substrate layer. The method may comprise coating the first layer on the substrate layer.

The method may comprise coating the second layer on the first layer.

The method may comprise providing a composition for coating the second layer. The composition may typically comprise a composition, e.g. a solution, of a polymer precursor, preferably of a silicon alkoxide precursor.

The silicon alkoxide precursor may be a compound represented by Formula (I):

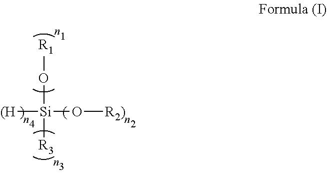

wherein R₁, R₂, R₃, are each independently an optionally substituted alkyl group, and
n₁, n₂, n₃, n₄ are each 0, 1, 2, 3 or 4, wherein n₁+n₂+n₃+n₄ equals 4.

The method may comprise coating, e.g. spin coating, the composition onto the first layer.

The composition may comprise water. The composition may comprise an aqueous solution of the polymer precursor.

The composition may further comprise a catalyst. The catalyst may be an acid such as hydrochloric acid, or a base such as sodium hydroxide.

The composition may further comprise a solvent, e.g. ethanol or acetonitrile.

The method may comprise mixing the polymer precursor, e.g. silicon alkoxide precursor, in water.

The method may comprise adding and/or mixing a/the solvent.

The method may comprise adding and/or mixing the first template. The first template may be dissolved in a/the solvent.

The method may comprise adding and/or mixing a/the catalyst.

The method may comprise controlling the pH of the composition with the catalyst, e.g. acid or base. Without wishing to be based by theory, it is believed that the polymerisation process, e.g. the condensation process, and therefore one or more properties of the resulting sol-gel polymer (such as porosity), can be controlled or manipulated by adjusting one or more of type of precursor, the ratio of precursor to water (“R value”), the type of catalyst, the pH and the reaction temperature. In particular, pH is believed to have a significant effect on the properties of the resulting sol-gel polymer. Under acidic conditions, hydrolysis is believed to be faster, leading to weak branching in the sol gel matrix. Under basic conditions, hydrolysis is believed to be slower and condensation occurs at a higher rate, which may lead to a more densely structured polymer matrix. Typically, the boundary between acid and base conditions is defined by the pH at which silica becomes electrically neutral (the isoelectric point). The isoelectric point for silica is pH 3.9 and may be used as a reference point for silicon alkoxides. Thus, typically, reactions where the pH is less than the isoelectric point of silica are therefore acid-catalysed, and reactions where the pH is greater than the isoelectric point are base-catalysed.

The molar ration of silicon alkoxide precursor to water may be in the range of about 1:1-1:10, e.g. 1:2-1:6, e.g. about 1:4.

The molar ration of silicon alkoxide precursor to solvent may be in the range of about 1:1-1:10, e.g. 1:2-1:8, e.g. about 1:6.

The molar ration of silicon alkoxide precursor to catalyst, e.g. acid or base, may be in the range of about 1:0.001-1:0.02, e.g. 1:0.005-1:0.01, e.g. about 1:0.007.

The method may comprise coating, e.g. spin coating, the composition onto the first layer.

The method may comprise heating the second layer, e.g. heating the apparatus, or example in an oven. Heating may be performed at about 40° C.-120° C., e.g. at about 50° C.-100° C., e.g. at about 60° C.-80° C.

The method may comprise removing the first template. The method may comprise washing at least the second layer, e.g. the apparatus, in a solvent or mixture of solvents, for example ethanol and/or acetic acid. The method may comprise immersing at least the second layer, e.g. the apparatus, in the solvent or mixture of solvents.

According to a third aspect, there is provided a method of detecting and/or measuring the presence of a target analyte in a sample, the method comprising:
providing an apparatus according to the first aspect in a photoluminescence detection chamber;
feeding the sample in the chamber;
irradiating the apparatus using a radiation source; and
measuring a photoluminescence response.

The method may comprise providing the sample in gaseous form or in liquid form. The method may comprise feeding a flow of the sample in vapour form through the chamber.

The method may comprise irradiating the apparatus with an exciting radiation. For example, the source of radiation may be a laser.

The method may comprise measuring photoluminescence quantum yields (PLQY). Alternatively, or additionally, the method may comprise measuring a relative photoluminescence response before and after feeding the sample. In other words, the method may comprise measuring a change in the photoluminescence response following feeding of the sample in the chamber.

It will be understood that the features described in respect of any aspect may be equally applicable in relation to any other aspect of the invention, and, merely for brevity, are not repeated.

### BRIEF DESCRIPTION OF DRAWINGS

Embodiments of the present disclosure will now be given by way of example only, and with reference to the accompanying drawings, which are:

FIG. 1 Examples of nitroaromatic compounds;

FIGS. 2(a) to (2b) Schematic representation of a spin coating process;

FIG. 3 Schematic representation of a spectralon-coated integrating sphere;

FIG. 4 graph showing fluorescence response of a thin film of polyfluorene (PFO) to dinoseb pesticide vapours;

FIGS. 5(a)-5(b) Schematic representation illustrating a method of preparing a sensing apparatus according to an embodiment;

FIG. 6 Schematic view of an apparatus for detecting a first analyte according to an embodiment;

FIG. 7 Post sensor fabrication process fluorescence and absorption spectra of PFO films, PFO films coated with DNT imprinted, acid-catalysed PTEOS sol gel, and PFO coated with non-imprinted, acid-catalysed PTEOS sol gel;

FIG. 8 graph showing PLQY results for an imprinted and non-imprinted PTEOS sol gel films in response to DNT exposure;

FIG. 9 graph showing PLQY results for an imprinted and non-imprinted PTEOS sol gel films in response to dinoseb exposure;

FIG. 10 Average response (n=3 for all samples) of PTEOS MISG sensors imprinted with DNT and exposed to dinoseb vapours, for different R values;

FIG. 11 Graph showing solid state photoluminescence and absorption spectra of uncoated PFO films alongside PFO films coated with imprinted and non-imprinted APTES sol gel;

FIG. 12 graph showing PLQY results for an imprinted and non-imprinted APTES sol gel films in response to DNT exposure;

FIG. 13 graph showing PLQY results for an imprinted and non-imprinted APTES sol gel films in response to dinoseb exposure;

FIG. 14 graph showing PLQY results for an imprinted and non-imprinted APTES sol gel films in response to DMDNB exposure;

FIG. 15 graph comparing the response of different films to different analytes.

### DETAILED DESCRIPTION

### Methods

### Spin Coating

The thin polymer films used as photoluminescent sensors were deposited onto a substrate via spin coating. Spin coating provides a reliable and repeatable way of coating thin films of polymers onto substrates.

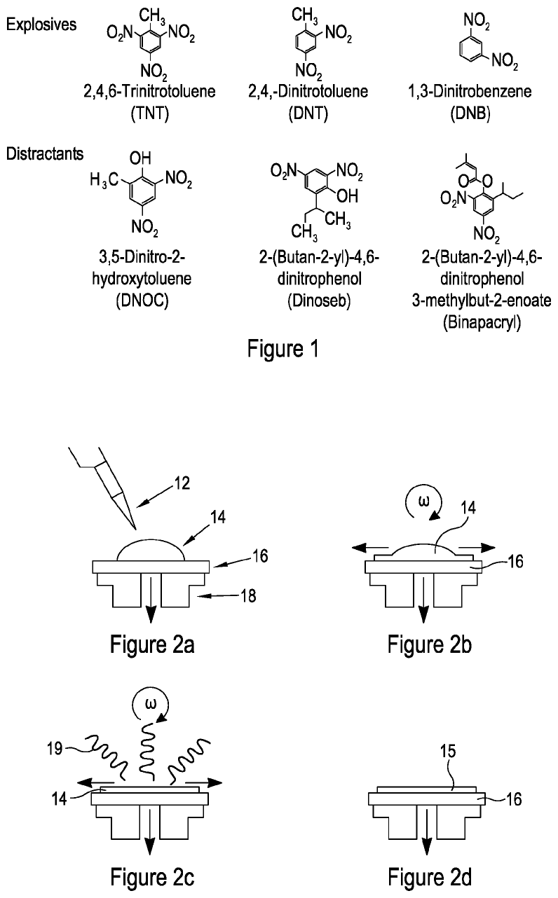

FIGS. 2(a) to (2(d) illustrate the spin coating process.

As shown in FIG. 2(a), a micropipette 12 is used to dispense a drop of polymer solution 14 onto a substrate 16. The substrate 16 is held onto the spin coating chuck 18 by vacuum.

In FIG. 2(b), the substrate 16 is accelerated to spin speed ‘w’ and centrifugal forces cause the drop 14 to spread out radially. Typically 100 μL of solution give good coverage for 25×25 mm substrates and 20 μL of solution give good coverage for 10×10 mm substrates. Centrifugal forces spread the polymer solution 14 out radially until the entire substrate 16 is covered in solution. Any excess solution is ejected outwards from the surface of the substrate 16.

As shown in FIG. 2(c), as the substrate 16 spins the solvent 19 evaporates. As the solvent evaporates from the solution 14 the viscosity rises quickly, which influences the final film thickness. The thickness of a spin-coated film can be controlled by varying the concentration of the polymer solution and the rotation speed. Varying the concentration of the solution gives coarse film fabrication control of the film thickness, which can then be finely tuned by adjusting spin speed. Spin coating speed was typically 2000 r.p.m for about 60 s using polymer solutions of 10 mg·ml⁻¹ concentration. This produced films of 100 nm thickness.

As shown in FIG. 2(d), after any excess solution has been ejected and the solvent evaporated, a thin film of polymer 15 has formed on the substrate 16.

### Photophysical Characterisation

### Absorption Spectroscopy

The optical absorbance, A of a material is defined by equation (1):

$$A = - {log}_{10} ( T ) \qquad ( 1 )$$

where T is the amount of transmitted light, defined as the ratio of intensities of incident and transmitted light (I/I₀).

The optical absorbance of samples was recorded on a Cary 300 UV-vis spectrophotometer. UV and visible emission lamps allowed for absorbance between 190-900 nm to be recorded with a resolution of 1 nm. Light from the lamps is passed through a monochromator, collimated then split between the sample and reference arm of the spectrophotometer. The transmitted light is collected using a photomultiplier tube and the absorbance calculated. The dual beam setup allows for effects such as substrate absorbance to be subtracted.

### Fluorescence Spectroscopy

Fluorescence spectra were collected using an Edinburgh Instruments FLS980 fluorimeter or an Andor CCD couple grating spectrometer. All spectra were recorded at room temperature and under ambient conditions.

Samples were excited using a 405 nm continuous wave diode laser (Power Technology IQ2A50(405-125)G26/A114) or a 355 nm solid state, diode pumped nanosecond pulsed laser (Crylas FTSS 355-Q). The intensity of the excitation source was controlled using neutral density filters to achieve a good signal to noise ratio while simultaneously minimising any photodegradation in the sample. The emitted light was collected with a fibre optic coupled to the grating spectrometer, and the output of the diffraction grating collected with a CCD detector. The number of counts recorded as a function of wavelength were used to plot an emission spectrum for the material.

### Photoluminescence Quantum Yield

Photoluminescence quantum yields (PLQY) were measured using the method developed by Suzuki et. al (Kengo Suzuki, Atsushi Kobayashi, Shigeo Kaneko, Kazuyuki Takehira, Toshitada Yoshihara, Hitoshi Ishida, Yoshimi Shiina, Shigero Oishi, and Seiji Tobita. “Reevaluation of absolute luminescence quantum yields of standard solutions using a spectrometer with an integrating sphere and a back-thinned CCD detector.” In: Phys. Chem. Chem. Phys. 11 (42 2009), pp. 9850-9860) using a Hamamatsu C9920-02 absolute PLQY instrument.

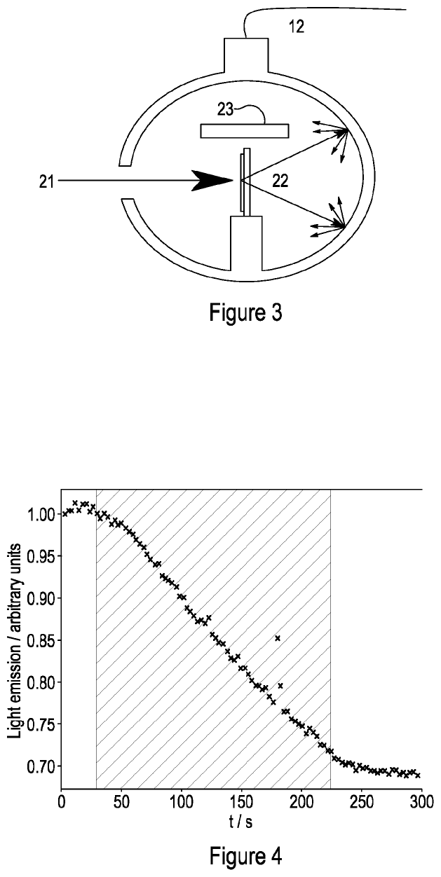

FIG. 3 illustrates a typical PLQY measurement setup 20, including an excitation beam 21, a sample 22, a baffle 23, and fibre optic 24 coupled to analyser.

### Physical Characterisation

### Florescence Response

FIG. 4 shows the fluorescence response of a thin film of polyfluorene (PFO) to dinoseb pesticide vapours. In FIG. 4, the grey-shaded area shows when the sensor was exposed to the contaminated vapour. Although typically not as strong as the response to an explosive-related nitroaromatic such as DNT, there is still a significant amount of quenching observed.

Thus, if the target analyte was an explosive type of compounds (such as those exemplified in FIG. 1), any detection method that shows a response to a distractant compound such as dinoseb (such as those exemplified in FIG. 1) will reduce the effectiveness of the sensing method due to lack of specificity, as an ideal sensor would only respond to the target analyte.

### Molecular Imprinting

The inventors have discovered that specificity can be introduced to photoluminescent polymer sensor materials through the process of molecular imprinting.

FIG. 5 illustrates a method of preparing a sensing apparatus according to an embodiment. The molecularly imprinted polymer layer of the present invention works through a ‘lock and key’ type mechanism by introducing molecular recognition sites for the target analyte.

As shown in FIG. 5(a), polymer precursors 31 (here silicon alkoxide precursors) having chemical groups which favourably interact with a target analyte 41 are mixed with the target analyte 41 (or with a similar template molecule). The precursors are then polymerised to form a polymeric network 32 including the template molecule 41, as shown in FIG. 5(b). The template molecule 41 is then removed by washing with a solvent or solvents, forming a polymer matrix 32 of recognition sites 33 for the target analyte 41, as illustrated in FIG. 5(c).

As shown in FIG. 5(d), the Molecularly Imprinted Sol-Gel (MISG) polymer matrix 32, when exposed to the target analyte 41, is therefore configured to allow the target analyte 41 to pass through the MISG matrix 32 and react with an adjacent photoluminescent layer material, which can induce a sensing response in the photoluminescent polymer, such as fluorescence turn on or quenching.

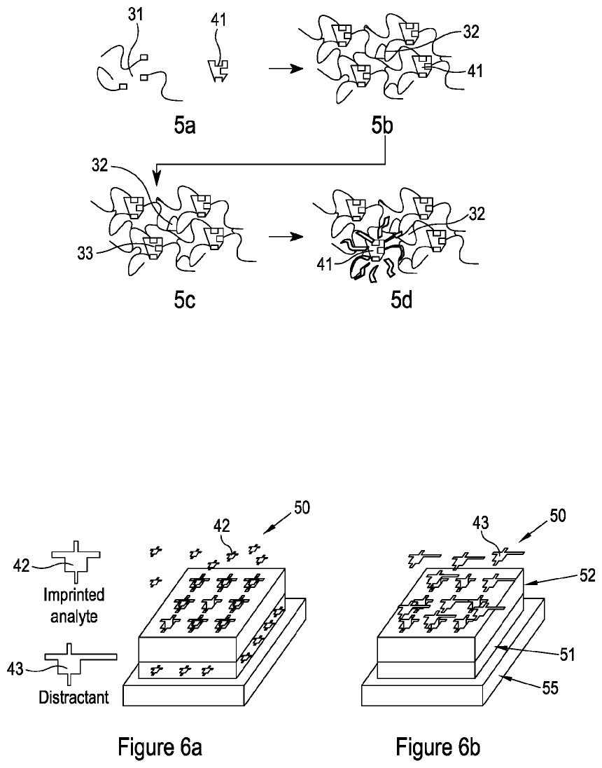

FIG. 6 is a schematic view of an apparatus for detecting a first analyte, according to an embodiment.

The apparatus 50 has a substrate layer 55 made of glass, a first layer 51 comprising a photoluminescent material disposed on the substrate layer 55, and a second layer 52 disposed on the first layer 51. The second layer is made of a MISG polymer described in relation to FIG. 5, which acts as a filter layer configured to allow a target analyte 42 to permeate through the second layer 52, but to block unwanted molecules, in this example a distractant 43.

As shown in FIG. 6(a), the MISG layer 52 allows the target analyte 42 to pass through the MISG layer 52 due to its imprinted structure, and thus interact with the sensing layer 51. However, as illustrated in FIG. 6(b), a different molecule 43 which could potentially quench the sensing layer 51 is not able to pass through the MISG layer 52. Therefore, advantageously, the provision of a molecularly imprinted sol-gel polymer layer 52 on top of the sensing layer helps provide or at least improve specificity for a target analyte 42 during detection thereof.

### Results and Discussions

### PTEOS Sol-Gel Layers

### Preparation of a PTEOS Sol-Gel Layer

A first MISG layer was prepared from a silicon alkoxide precursor comprising a mixture of n-propyltriethoxysilane (PTEOS) and trimethoxy(3,3,3-trifluoropropyl)silane (TFP-TMOS).

PTEOS and TFP-TMOS were mixed at a 1:1 molar ratio. Ethanol was added as a solvent along with deionised water and hydrochloric acid (HCl) at a silane:ethanol:water:acid molar ratio of 1:6.25:4:0.007. Varying the molar ratio of water to silanes allows for control of pore size in the sol gel film. The silane: water molar ratio of 4:1 was chosen as a starting point. The acid catalysed route was used as it produces the most optically clear films, due to the lower level of cross-linking between precursors.

To imprint the sol gel 2,4-dinitrotoluene (DNT) was chosen as a template molecule and dissolved in acetonitrile. The DNT solution was added to the sol gel at a molar ratio of 1:10 DNT:PTEOS.

The equivalent amount of acetonitrile was added to create non-imprinted sol gels.

The solution was left to stir overnight before spin coating on top of the sensor films.

The sensor films were prepared from a solution of polyfluorene (PFO) solution dissolved in toluene at a concentration of 10 mg ml⁻¹, and spin coated onto 10 mm×10 mm glass substrates by the method described above with reference to FIG. 2.

The sol gel solution was then spin coated on top of the PFO films then baked in an oven at 60° C. for 72 h. Usually slightly higher temperatures are used to prepare sol gels however curing at a lower temperature for longer avoids any heat related damage to the conjugated polymer sensor film.

Following baking, the films were removed and placed in a bath of ethanol and acetic acid mixed at a molar ratio of 1:3 for 2 h to remove the template molecule. The acidified solvent mixture was chosen to provide protons to help with the removal of DNT molecules.

### Characteristics of PTEOS Sol Gels

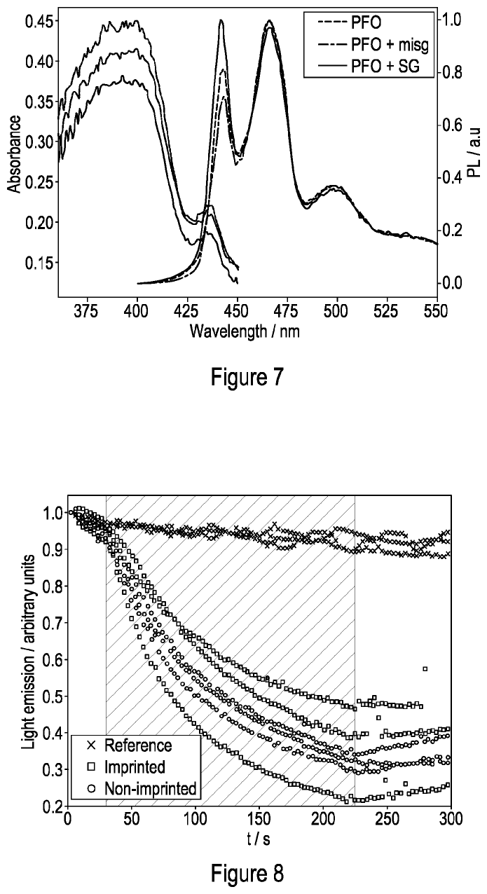

The fluorescence and absorption spectra of films coated with imprinted and non-imprinted acid catalysed PTEOS sol gels alongside uncoated PFO films are shown in FIG. 7. The uncoated PFO films were baked and washed alongside the sol gel samples to investigate the effect of the fabrication process on the sensing film.

FIG. 7 shows post sensor fabrication process fluorescence (solid lines) and absorption (dashed lines) spectra of PFO films (green lines), PFO films coated with DNT imprinted, acid catalysed PTEOS sol gel (black lines) and PFO coated with non-imprinted, acid catalysed PTEOS sol gel (red lines).

Each of the sensors displays similar absorption and fluorescence spectra. The slight differences in absorption spectra are likely due to the scattering introduced by the sol-gel layers. The relative intensities of the fluorescence peaks at 430 nm and 470 nm suggest a lower fraction of crystalline beta-phase present in the PFO. This is due to the 72 h, 60 C bake step of the fabrication process affecting film morphology. This did not appear to negatively affect the sensing performance of the films.

### Effect of Imprinting PTEOS Sol Gels

To test the response of the bilayer sensors to explosive and pesticide vapours, each film was placed into a sealed test chamber and exposed to vapours of the desired analyte.

The samples were exposed to a 10 L·min⁻¹ flow of nitrogen gas carrying the test vapour while being excited by a 405 nm CW diode laser.

Samples coated with DNT imprinted and non imprinted PTEOS sol gel were first exposed to DNT vapours to investigate if the imprinted sol gel impeded access of the target molecule to the sensor film below, as shown in FIG. 8. Specifically, FIG. 8 shows the average response of PFO films coated with DNT-imprinted (red crosses) (n=3) and non imprinted (green crosses) (n=3) PTEOS sol gels to DNT vapours. The average response of a bare PFO film to clean nitrogen (black crosses) (n=3) is given as a reference. Shaded area shows when DNT vapours were introduced into the sensing chamber.

Both the imprinted and non-imprinted sol gels show a significant drop in light emission upon exposure to DNT vapours. The sensing response also occurs at a similar rate for the both the non-imprinted and imprinted sol gels. This suggests the DNT vapour passes through the imprinted layer without impedance.

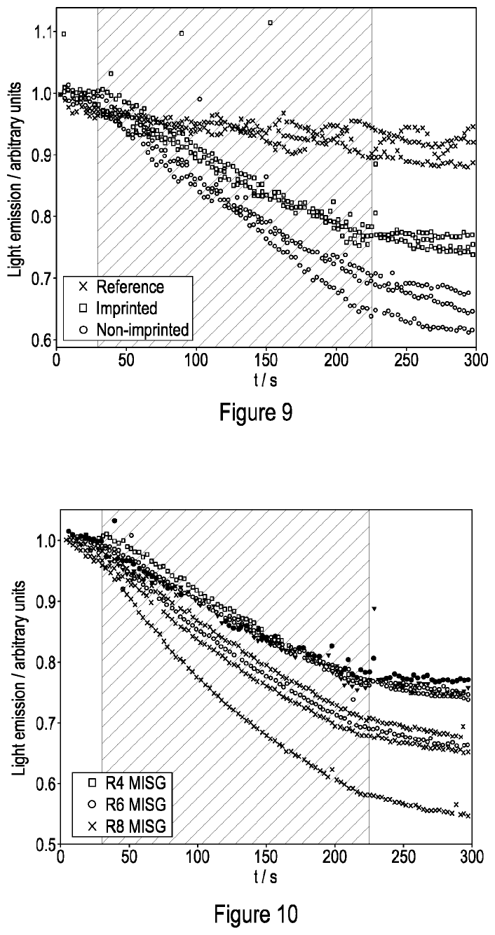

The experiment was repeated with fresh sensors prepared in the same way and exposed to dinoseb vapours. As shown in FIG. 9, the imprinted sol gel reduces the response of the PFO sensor by approximately 10% compared to the non-imprinted films.

### Effect of Varying Sol Gel Porosity

As mentioned above, varying the amount of water in the sol-gel films can alter the size of the pores in the glass-like matrix created. The molar ratio of water to silane precursor is known as the R value. The sol-gels fabricated in relation to FIGS. 7 and 8 had an R value of 4. Increasing the R value decreases porosity by reducing pore size. It was thought that increased pore size would likely reduce the effect of any imprinting, allowing the larger pesticide molecules to pass through the sol gel layer easily. Sol gels with smaller pore sizes were investigated using sol gels with R values of 6 and 8. These were tested in the same way described above.

FIG. 10 shows the average response (n=3) of PFO films coated with DNT-imprinted sol gels of decreasing porosity, and exposed to dinoseb vapours. Red crosses show the response for R=4, blue crosses for R=6 and green crosses for R=8.

Decreasing the porosity reduces the ability of the imprinted sol-gel to block dinoseb vapours. This may be due to cracks forming in the more tightly pored film allowing more access to the film, or the tighter pores not including the DNT template molecules for imprinting. This could also explain the increase in variation in response seen with increasing the R value.

### APTES Sol-Gel Layers

### Preparation of an APTES-Based Sol-Gel Layer

A second MISG layer was prepared from a silicon alkoxide precursor comprising a mixture of (3-aminopropyl)triethoxysilane (APTES) and tetramethyl orthosilicate (TMOS).

APTES contains an amine group which interacts strongly with nitroaromatics due to their electron deficiency. Sol gels containing this precursor were coated onto PFO sensors and tested to investigate if they could increase the exclusion of dinoseb vapours from the PFO sensor film.

The APTES sol gels were made by mixing APTES, TMOS and ethanol at a 1:1:5 molar ratio. 1 M Sodium Hydroxide (NaOH) in water solution was added at a molar ratio of 1:0.002 while stirring the mixture with a magnetic stirrer and left for 30 min to react. Thus the molar ratio of silane:ethanol:water:NaOH was 1:1:5:1:0.002. It was found that chilling the NaOH solution to 4° C. produced the best results as it slowed down the hydrolysis of the sol gel and avoided the formation of large glassy clumps.

To imprint the sol gel, DNT was added at a molar ratio of DNT:APTES 1:10 from an 18.2 mg ml⁻¹ acetonitrile solution.

For non-imprinted sol gels the equivalent amount of clean acetonitrile was added to the mixture.

The solutions were then filtered through a 0.1 μm syringe filter to remove any small glassy clumps formed and improve the optical clarity of the films produced. The sol gel was deposited on top of PFO films via spin coating at 2000 rpm and baked for 60 s at 80° C.

The samples were then placed in a 3:1 molar ratio acetic acid:ethanol mixture for a minimum of two hours before being removed and dried. The acid/solvent mixture was used as the acid provides protons to aid in the de-binding of the DNT from the amine group provided by the APTES. A based catalysed PTEOS sol gel was also created for comparison using the same recipe, with the APTES swapped for PTEOS at the same molar ratio.

### Characteristics of APTES MISG Coated PFO

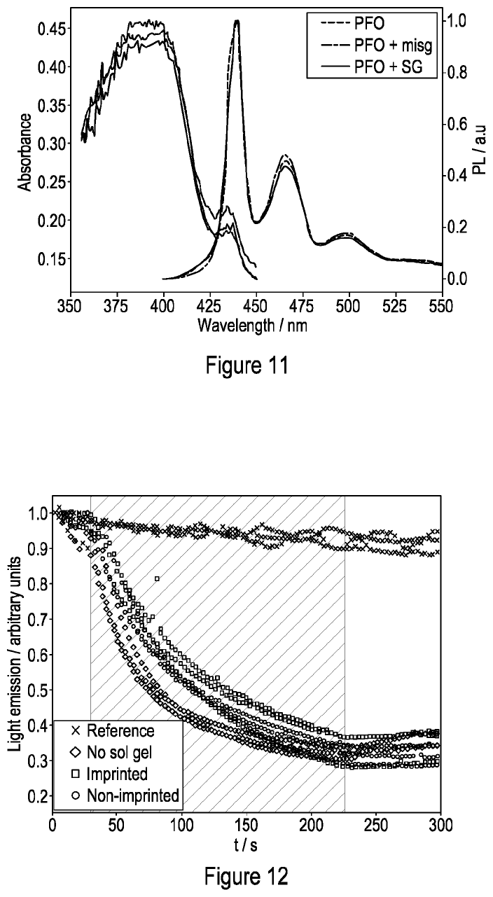

FIG. 11 shows solid state photoluminescence emission (solid lines) and absorption (dashed lines) spectra of PFO films without sol gel coating (green lines), PFO films with imprinted APTES sol gel coating (black lines), and non-imprinted APTES sol gel (red lines).

The presence of imprinted or non-imprinted sol gel does not appear to influence the absorption or emission spectra of the PFO films beneath. The slight variations between the three traces is believed to be due to the small amount of scattering caused by the sol gel layers.

The effect of the fabrication process on the PFO film was monitored by measuring the PLQY of the PFO film at various steps of the fabrication process. This also allowed the extraction of the DNT template to be monitored. Table 3 shows the variation in PLQY throughout the fabrication process for PFO films coated with either base-catalysed APTES-based or base-catalysed PTEOS-based sol gels imprinted with DNT.

TABLE 3

| | Before sol- | PLQY | (%) | |
|---|---|---|---|---|
| Sample | gel coating | Pre-bake | Post-bake | Washed |
| Uncoated PFO | 42 | 41 | 43 | 32 |
| PFO + PTEOS MISG | 41 | 1 | 7 | 22 |
| (base catalysed) | | | | |
| PFO + APTES MISG | 42 | 7 | 9 | 29 |
| (base catalysed) | | | | |

As can be seen from Table 3, both the base-catalysed PTEOS and APTES sol gels show a significant decrease in PLQY after the application of the DNT layer. There is however a modest difference between the based catalysed APTES and base catalysed PTEOS sol gels. The PFO films coated with imprinted APTES sol gel have a PLQY that is 6% greater than the PLQY of PFO films coated with PTEOS sol gel. Both types of sol gel film contain a comparable amount of DNT, which indicates the binding of DNT to the amine groups in the APTES is responsible for the slightly higher PLQY.

The binding of DNT to APTES molecules prevents excess DNT migrating into and quenching the fluorescence of the PFO film below. This is further supported by the smaller increase in PLQY observed in APTES based samples after the bake step, as the heating cannot supply enough energy to de-bind DNT from the APTES sol gel matrix. The PLQY of the sensors does not recover back to its original, pre-coating value after the wash step. This indicates not all of the imprinting molecules are removed from the samples. However this did not cause any detrimental effect in the performance of the sensors as the template molecules that are washed out of the film create direct imprinted pathways to the PFO film below.

The film thickness of the PFO was found to be 50 nm when measured on a Veeco Dektak 150 surface profiler. FIB SEM images gave a typical thickness of 250 nm of the sol gel layer.

### Effect of Imprinting APTES-Based Sol Gel

Samples of uncoated PFO films, plus PFO films coated with imprinted APTES sol gel (MISG) and non-imprinted APTES sol gel (SG) were prepared using the method described above. The samples were then placed into a sealed chamber connected to the vapour generator. The samples were exposed to a 10 L·min⁻¹ flow of either clean nitrogen or DNT vapour while being excited by a 405 nm CW diode laser. Three of each type of sample were measured in order to demonstrate reproducibility. The responses are shown in FIG. 12, which shows response of uncoated PFO films (blue crosses), APTES MISG coated PFO films (red crosses) and APTES SG coated PFO film (green crosses). The shaded area shows when the sensors are exposed to DNT vapours. The response of an uncoated PFO film to clean nitrogen only is shown as a reference (black crosses).

FIG. 12 shows PFO films coated with DNT imprinted APTES sol gel and exposed to DNT vapours show a similar response to uncoated PFO films and films coated with non-imprinted APTES sol-gel. This indicates the DNT-imprinted sol gel does not hinder access to the PFO film below when exposed to the template molecule. The rate at which the PFO fluorescence is quenched is slightly slower than the rate seen in uncoated films. For films coated with sol-gel there is an extra 250 nm of material for the vapour to diffuse through before reaching the PFO film below, which is believed to be the cause for this difference.

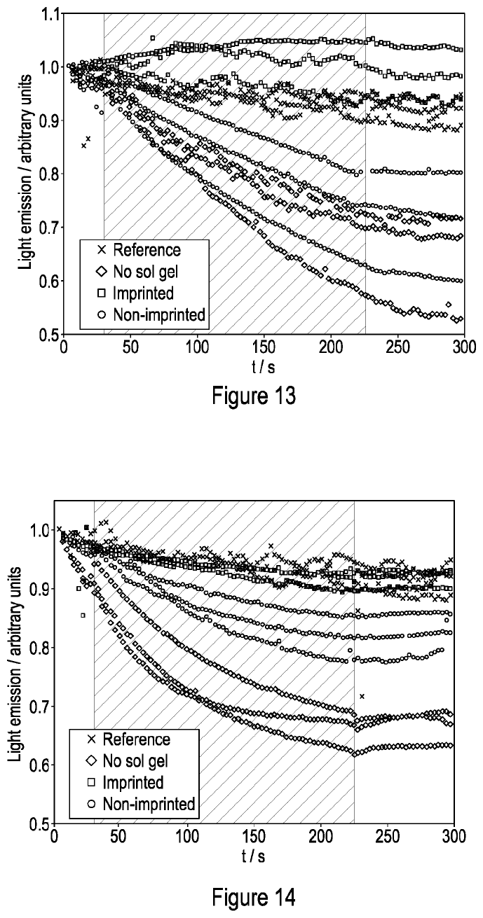

FIG. 13 shows responses for the same films as those tested in FIG. 12, but exposed to dinoseb vapours.

As shown in FIG. 13, the DNT-imprinted APTES MISG layer effectively blocks dinoseb vapours from accessing the PFO film below. The photoluminescence of MISG coated PFO films tends to increase during the experiments. This is thought to be due to the combination of flowing vapour and the laser excitation removing residual DNT template molecules from the sol gel film left behind after the wash step.

To further test the effectiveness of the APTES molecular imprinted sol gel as a blocking layer for distractant molecules the response of PFO films coated with non imprinted and imprinted APTES sol gels to 2,3-dimethyl-2,3-dinitrobutane (DMDNB). DMDNB is often used as a taggant to allow for easier detection of plastic explosives by sniffer dogs, and triggers a response in PFO sensors. It also possesses a very different molecular structure to both DNT and Dinoseb, as shown in Table 2.

The response of uncoated PFO along with PFO coated with imprinted and non imprinted APTES sol gel to DMDNB vapours was measured and the results are shown in FIG. 14, which shows response of uncoated PFO films (blue crosses), non-imprinted APTES sol gel coated PFO film (blue crosses) and imprinted APTES sol gel films (red crosses) to DMDNB vapours. The shaded area shows when the sensors are exposed to DMDNB vapours. The response to PFO exposed to a flow of clean nitrogen (black crosses) is shown as a reference.

There is very little response to DMDNB for sensors coated with DNT-imprinted MISG. The slight increase seen in the imprinted sensors in FIG. 13 is not seen in those exposed to DMDNB. DMDNB is a much smaller molecule than dinoseb. As a result, a small fraction of molecules may be able to pass through the molecular recognition sites in the imprinted film and quench the PFO below, counteracting any rise in photoluminescence from the laser excitation and vapour flow extracting excess DNT template. The response is still comparable to the reference response to nitrogen vapour containing no analytes, showing that the MISG layer blocks the majority of DMDNB molecules from accessing the film below.

In summary, FIGS. 12, 13 and 14 show the effectiveness of the base-catalysed APTES based molecular imprinted sol gels. These MISGs effectively block molecules with structures that do not match the template molecule, reducing the response of the PFO sensor film to these vapours while allowing the imprinted molecule access to the PFO film below. These MISGs have much superior performance to the acid catalysed PTEOS-based sol gels discussed earlier. To confirm that the increase in the imprinting performance is due to the binding of DNT to the amine groups provided by the APTES precursor rather than the base catalysis, the response of APTES and PTEOS base catalysed imprinted sol gels to DNT, dinoseb and DMDNB vapours was measured. This was done to establish whether the imprinting effect is introduced by the “locking-in” of DNT molecules by the amine groups on the APTES, rather than effects such as the increased surface roughness of a base-catalysed sol gel.

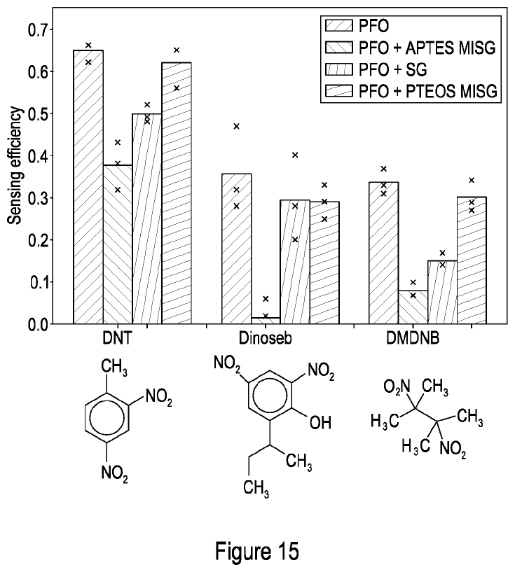

The results are illustrated in FIG. 15, which shows the average responses to uncoated PFO (green bars), PFO coated with APTES MISG (grey bars), PFO coated with APTES sol gel (red bars) and PFO coated with base catalysed PTEOS MISG (blue bars). Crosses show individual measurements.

FIG. 15 shows that a base-catalysed PTEOS MISG does not possess the identical blocking properties as an APTES based sol gel, confirming that the blocking properties are in part due to the interaction between APTES and DNT. The base-catalysed PTEOS based imprinted sol gel has comparable sensing performance to the uncoated PFO films. This shows the importance of the interaction between the DNT template and the sol gel matrix in the imprinting process.

FIG. 15 also shows that the APTES-based MISG exhibited a good response to DNT (which was used as template for the MISG), but a minimal response to dinoseb and much reduced response to DMDNB, thus evidencing the specificity of the MISG layer.

It will be appreciated that the described embodiments are not meant to limit the scope of the present invention, and the present invention may be implemented using variations of the described examples. For example, whilst the present examples have been carried out using nitro-aromatic compounds as the first analyte, it will be understood that the principles of the present invention could be applied to the selective detection of other types of analyte.

1. An apparatus for detecting a first analyte, the apparatus comprising:
a first layer comprising a photoluminescent material; and
a second layer provided on the first layer, wherein the second layer comprises a polymeric material configured to allow the first analyte to permeate through the second layer.

2. An apparatus according to claim 1, wherein the photoluminescent material is capable of being quenched by the first analyte.

3. An apparatus according to claim 1, wherein the first layer is provided as a film.

4. An apparatus according to claim 1, wherein the second layer comprises a sol-gel material.

5. An apparatus according to claim 4, wherein the second layer comprises a polysiloxane sol-gel.

6. An apparatus according to claim 5, wherein the second layer is formed by polymerisation of a composition comprising a silicon alkoxide precursor.

7. An apparatus according to claim 6, wherein the silicon alkoxide precursor is a compound represented by Formula (I): 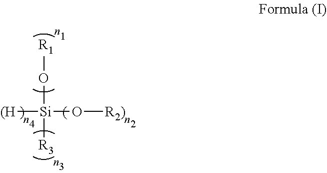
wherein R₁, R₂, R₃, are each independently an optionally substituted alkyl group, and
n₁, n₂, n₃, n₄ are each 0, 1, 2, 3 or 4, wherein n₁+n₂+n₃+n₄ equals 4.

8. An apparatus according to claim 7, wherein n₄=0.

9. An apparatus according to claim 6, wherein the silicon alkoxide precursor is a compound represented by Formula (I) a: 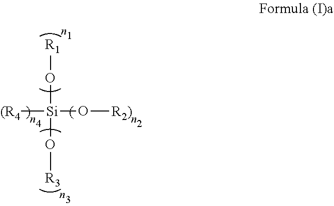
wherein R₁, R₂, R₃, are each independently an alkyl group,
R₄ is independently an optionally halogenated or aminated C1-C5 alkyl group, and
n₁, n₂, n₃, n₄ are each 0, 1, 2, 3 or 4, wherein n₁+n₂+n₃+n₄ equals 4.

10. An apparatus according to claim 9, wherein n₄=1.

11. An apparatus according to claim 6, wherein the silicon alkoxide precursor comprises one or more compounds selected from the list consisting of n-propyltriethoxysilane (PTEOS), trimethoxy(3,3,3-trifluoropropyl)silane (TFP-TMOS), (3-aminopropyl)triethoxysilane (APTES), and tetramethyl orthosilicate (TMOS).

12. An apparatus according to claim 6, wherein the silicon alkoxide precursor comprises n-propyltriethoxysilane (PTEOS) and trimethoxy(3,3,3-trifluoropropyl)silane (TFP-TMOS).

13. An apparatus according to claim 6, wherein the silicon alkoxide precursor comprises (3-aminopropyl)triethoxysilane (APTES) and tetramethyl orthosilicate (TMOS).

14. An apparatus according to claim 1, wherein the second layer is provided as a coating on the first layer.

15. An apparatus according to claim 1, wherein the second layer is imprinted with a first template selected to allow the first analyte to pass through the second layer, wherein the first template is substantially identical to or is similar to the first analyte.

16. (canceled)

17. An apparatus according to claim 15, wherein the first analyte is a nitro-containing compound, wherein the second layer is configured to allow passage of the first analyte through the second layer, and to prevent or limit passage of other nitro-containing compounds therethrough.

18. A method of preparing an apparatus for detecting a first analyte, the method comprising:
providing a first layer comprising a photoluminescent material; and
providing a second layer on the first layer, wherein the second layer comprises a polymeric material configured to allow the first analyte to permeate through the second layer.

19. A method according to claim 18, wherein the method comprises coating the first layer on a substrate layer, and/or wherein the method comprises coating the second layer on the first layer.

20. (canceled)

21. A method according to claim 18, wherein the method comprises providing a composition for coating the second layer, the composition comprising a solution of a silicon alkoxide precursor, wherein the method comprises adding and/or mixing a first template in the composition, and wherein the method comprises coating the composition onto the first layer.

22. (canceled)

23. (canceled)

24. A method according to claim 21, comprising heating the second layer to a temperature of about 40° C. to about 120° C.

25. A method according to claim 21, comprising removing the first template.

26. A method of detecting and/or measuring the presence of a target analyte in a sample, the method comprising:
providing an apparatus according to claim 1 in a photoluminescence detection chamber;
feeding the sample in the chamber;
irradiating the apparatus using a radiation source; and
measuring a photoluminescence response.
